(19) United States
(12) Patent Application Publication
(10) Pub. No.: US 2007/0157073 A1
(43) Pub. Date: Jul. 5, 2007

(54) Software weaving and merging

(75) Inventor: Pradeep Varma, New Delhi (IN)

Correspondence Address: IBM ALMADEN (AVE);c/o LAW OFFICE OF ANTHONY ENGLAND, P.O. BOX 5307, AUSTIN, TX, 78763, US

(73) Assignee: International Business Machines Corporation

(21) Appl. No.: 11/321,176

(22) Filed: Dec. 29, 2005

(51) Int. Cl. G06F 17/00; G06F 15/00

(52) U.S. Cl. 715/501.1

(57) ABSTRACT

There is disclosed transforming an electronic plain text to an electronic anchored text, comprising inserting anchors located between characters in said plain text. Each character has a unique association with a nearest preceding or succeeding anchor. Each anchor serves as a join point and specifies a predetermined state and a predetermined operation. There is also disclosed the weaving and merging of two or more electronic plain texts.

### FIELD OF THE INVENTION

This invention relates to the field of software weaving and merging, and particularly for text-based programs.

### BACKGROUND

One of the most common software maintenance activities relates to porting or migration of software from one platform to another. Porting in source form preserves the software and documentation in its entirety and is suitable for further development of the existing codebase.

Consider the code fragment 10 shown in FIG. 1, which shows porting concerns for an Endian dimension and an old CFront-style ‘for’ loop. The integer j declared in the ‘for’ loop is visible beyond the body of the loop, e.g. line 6. In modern loops, e.g. C99 (ANSI/ISO 9899:1999, C standard), loop-declared variables are visible within the loop body only and porting such a loop requires a fix such as lifting the variable declaration to the surrounding scope of the loop. The Endian concern in FIG. 1 is manifested in the initialisation code of j, wherein a conditional expression seeks to detect the Endian platform of the underlying hardware in order to lift out the most significant byte of the union type a. For big Endian, this is the 0th byte, as culled by the consequent branch of the conditional and for little Endian, this is the 3^{rd} byte. The detection predicate uses a common Endian detecting idiom. The detection relies on a difference in sizes of the types involved, which are long and int in the predicate, line 3, of FIG. 1. Use of ‘long’ and ‘int’ in FIG. 1 is faulty, since these types are commonly the same size, as on 32-bit platforms. A simple fix is casting to a smaller type, e.g. char and char* instead of integer. Regardless, porting concerns like the ones in FIG. 1 are identified and made available for correction simultaneously in a batch run of many dozens of detectors. In any given porting iteration, a user is free to decide what subset of concerns to address in order to migrate the software to its next dialect checkpoint.

In order to be language, dialect, and a detector/transformer's internal-form independent, concerns (i.e. their implicit program transformations/edits ) are stored in (anchored) text form. Weaving the transformations contained in a set of simultaneous concerns faces the problem of causality and intention preservation. Briefly, weaving the Endian fix straightforwardly, in the context of plain text occurs in two steps, the first replacing say ‘int’ at second arrow, line 3 (reading left to right) by char, the second replacing the ‘int’ cast at the third arrow by a char cast. The first replacement however invalidates the position pointed to by the second replacement, so that if unadjusted, it replaces “(in” instead of ‘int’ in the text representation. Similarly, weaving the Endian fix interferes with the for-loop's fix and vice versa. This interference has to be handled and minimized in order to maximize the weaving process.

Merge tools have evolved from state-based systems to operations-based systems over time. The evolution can be viewed as the extent of information captured for the merge system in order to detect and resolve conflicts. An example of an operations-based merge tool is taught in Lippe, E., and Oosterom, N. V., “Operation-based merging”, in Proc. ACM SIGSOFT Symposium on Software Development Environments, (SDE ′92), November 1992, ACM Press, 78-87. Such known state- and operations-based merge tools operate on plain text, which obtains the advantage of generality in handling as all kinds of source programs in different languages and documentation and other text objects. Working with plain text alone, straightforwardly, however loses the advantage of specificity of individual language contexts, so that merged changes are not checked syntactically and semantically for consistency with their surrounding context. Another disadvantage of working with plain text as opposed to an internal representation of the program like the abstract syntax tree/graph (AST/ASG) is the need to solve the causality and intention preservation problems in its full generality.

The program weaving problem is commonly defined in terms of combining well-defined program objects with well-defined combination rules. The source-to-source weaving problem reduces to temporally partially-ordered edit sequences on source text, which has the same form as the change merging problem on program text.

### SUMMARY

There is disclosed transforming an electronic plain text to an electronic anchored text, comprising inserting anchors located between characters in said plain text. Each character has a unique association with a nearest preceding or succeeding anchor. Each anchor serves as a join point and specifies a predetermined state and a predetermined operation.

There is also disclosed the weaving two or more electronic plain texts. The weaving includes the step of transforming each electronic plain text to an electronic anchored text by inserting anchors located between characters in said plain text. Each character has a unique association with a nearest preceding or succeeding adjacent anchor, and each anchor serves as a join point and specifies a predetermined state and a predetermined operation. One or more of the operations of copying, cutting and pasting are performed on the anchored text or character strings associated with a anchor from one anchored text to another anchor point in another anchored text.

The merging two or more electronic plain texts is also disclosed. Each electronic plain text is transformed to an electronic anchored text by inserting anchors located between characters in the plain text. Each character has a unique association with a nearest preceding or succeeding adjacent anchor, and each anchor serves as a join point and specifies a predetermined state and a predetermined operation. Differences among two plain texts are identified and expressed as a part of the predetermined operations. The predetermined operations are executed on one of the transformed texts to bring it to a merged state.

Anchors in the code sources serve as first-class join points for weaving remedial advice through the sources. Anchors can be defined anywhere, and these join points can be passed around as first-class objects in the weaving process. Porting concerns are applicable simultaneously (multi-dimensional separation of multi-target porting concerns), in order to allow for choice of a desired subset for a given port. Form-checking rules can be specified with individual concerns, to verify their correct weaving.

The static weaver is defined denotationally, mapping a program and applicable concerns to a set of correctly formed, weaved programs. The simultaneous concerns model can be viewed as an offline, concurrent change weaving problem, according to which a direct implementation of the weaving semantics is provided.

The anchored text solution solves the causality and intention preservation problems trivially, just as ASTs do in syntax tree program representations. This is because the entire original program gets partitioned into strings anchored by distinct anchors and operations are defined as succeeding or preceding these anchors and anchored strings. Anchors serve as pointers to their corresponding strings analogous to the strings pointed to by their containing AST nodes. Unlike AST nodes however (each of which is distinct), anchors and anchor ranges are extensively duplicated as a result of copy operations and continue on to get modified separately while holding on to their common anchor identities and thus respond to group operations defined in terms of common anchors. Although similar in identifying initial commonality, this mechanism works oppositely of the common subexpression elimination optimisation, wherein node sharing is used to tie (and, unfortunately, fix) commonality.

### DESCRIPTION OF THE DRAWINGS

FIG. 1 shows a C program fragment with porting concerns.

FIG. 2 is a schematic block diagram of a method for merging/weaving sessions embodying the invention.

FIG. 3 is a listing of the ParEdit syntax.

FIG. 4 shows an example of reference and sub anchors.

FIG. 5 shows example weaver semantics domains.

FIG. 6 shows an example revision plan and molecules' weaving.

FIG. 7 shows an example weaving string paste.

FIG. 8 shows an example weaving anchored text cut.

FIG. 9 shows an example weaving string cut.

FIG. 10 shows an example weaving anchored text copy.

FIGS. 11 and 12 show an example weaving anchored text paste.

FIG. 13 shows an example working text as an association list.

FIG. 14 shows example ANSI/ISO C99 expression labels.

FIG. 15 shows a computer implementation for the example software merging and weaving.

### DETAILED DESCRIPTION

### Overview

The weaving technique described hereinafter uses anchored text, as opposed to plain text, in constructing an operations-based merging system using three basic operations—cut, copy, and paste. Compound operations such as replace and shift are defined as macros in terms of these primitive operations (viz. cut and paste for replace, and copy, cut and paste for shift). Thus a new kernel system for text-based operations merging is implemented.

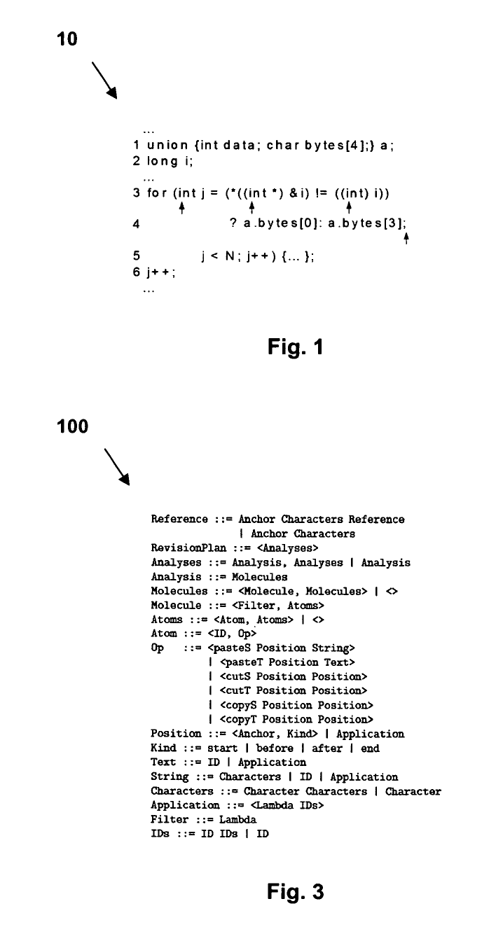

Anchored text is constructed by transforming plain text to include explicit anchors corresponding to positions in the unmodified, initial text. The initial text remains as a read-only reference, to relate anchors to, throughout transformations. Modifications shift the embedded anchors around, just like ordinary text characters, thus positions relative to anchors remain unchanged and operations defined in terms of anchors continue to preserve their intention, without the need for any operation transformations. In the example of FIG. 1, the arrows shown become anchors themselves. Shifting the index variable declaration to the surrounding scope is defined in terms of an edit from the first arrow to the last. The shift moves the middle two arrows to the new position and the Endian edits continue to be defined in the new position vis-à-vis the embedded arrows. Note that in the known scenario of moving as plain text, the inserted text in the new position is undistinguishable from a freshly constructed string of the same value as the text being moved. While intention preservation would seek applicability of operations pertaining to text being moved, it would not seek to apply original operations to freshly constructed text. Such discrimination is lost in the use of plain text, but with anchored text, the information is straightforward to maintain as the embedded anchors are available only in the copied text and not in the freshly constructed text. Note also that while an approach like operation transformation can attempt intention preservation by analysing the exact set of operations and the copy operations involved, the language of text manipulation, of combining copied text with freshly-generated text has to be limited to being statically analysable. The use of embedded anchors as values, allows arbitrary computations without such limits.

Anchors serve as join points where advice defined by the simultaneous edit operations is implemented. Each anchor represents a sequence of adjacent characters in the original text, a simple partitioning of the original text being one anchor per lexer token. Whitespace between lexer tokens would get its own anchored text representation comprising say one anchor per largest contiguous whitespace token. Many other source text partitionings are possible, e.g. anchoring each comment line distinctly, or breaking the comment down into individual words. The finest level of granularity for anchors is to have one anchor per character in the source text. The choice of partitionings is in general policy driven, based upon anticipated usage by edit operations in transformation sessions. Anchored text may be re-partitioned between transformation sessions by converting it into plain text and choosing a new partitioning for the next session. The re-partitioned anchored text may retain some duplicate anchors from the working text of the previous transformation session, these options are policy driven.

Advice bundled with an anchor may seek to precede the character sequence represented by the anchor, or succeed it, or to modify the sequence itself. A sequence of advice operations may seek similar positioning vis-à-vis each other, as for instance in negating a float variable prior to casting it to an unsigned integer. These operations can commute with each other so long as the negation advice can specify itself as the innermost modification in the text, next to the original variable and the cast operation can specify itself as the outermost modification, next to the original variable. The ability to specify such details is important, in order to allow controlled buildup of weaved advice, such as copying a built up region to another position in the program. Passing around of anchored text as parameters to advice operations is also allowed, which achieves the general advice weaving power of parametric introductions.

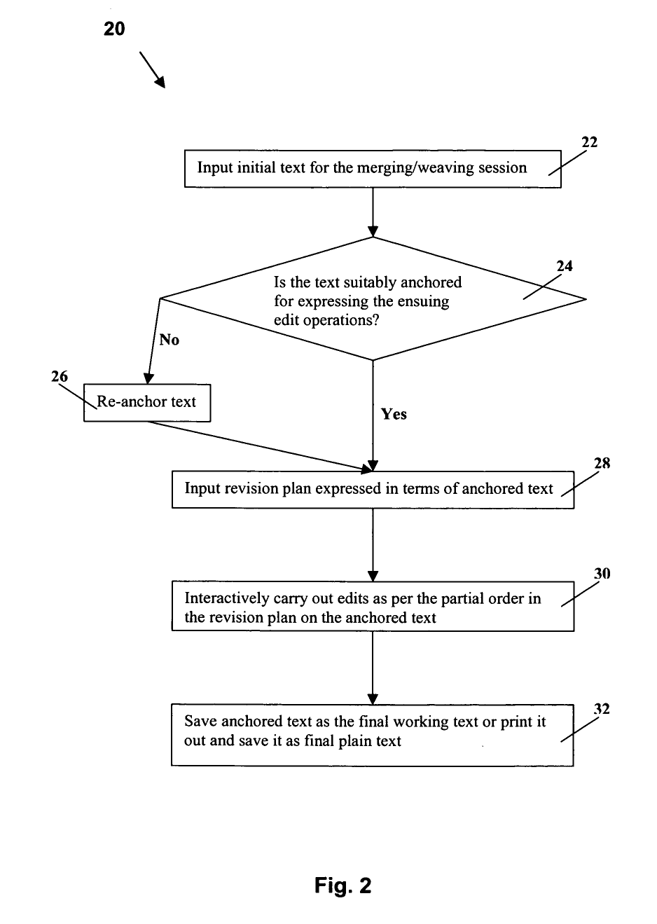

FIG. 2 is a block diagram showing how a given merging/weaving session 20 can be organized. The text to be transformed is input first at step 22, in either plain text form or a-priori anchored text form. The anchored text form may be a saved result from an earlier merging/weaving session. Regardless, the input text needs to have anchors that best suit the ensuing edit operations that need to be expressed in terms of the anchored text. At step 24, the flow tests whether the text is suitably anchored. If “no”, then the flow passes to step 26 where the text is reanchored. If “yes”, then the flow passes to step 28.

The anchoring policy for the merging session determines the set of anchors to have in place for the session (e.g. word based, lexeme based etc.). Source transformers which seek to modify the input text have to work with this policy and express their transformations in terms of the anchor granularity. One simple manner to derive a policy for a merge session is to note the preferred policy of each transformer that will be active in the session and to use a common acceptable policy for all transformers as the anchoring policy. In the worst case, no common policy may exist and character-level anchors have to be assumed, which we will discuss separately later.

Being able to re-use an a-priori anchored text implies that commonality such as copied text contained in the a-priori text continues to be recognized and re-used. If the earlier structure is sought to be cleared explicitly, or brought into conformance with a new anchoring policy, the most straightforward mechanism to do so is to print the document into plain text and then to re-anchor the plain text according to the new policy. The re-anchoring might be driven by the desire to focus on a different structure than the a-priori structure and new anchors and anchor copies sought to be inserted into the plain text. Besides the print and re-anchor route, other transformations are also straightforward since anchored text is a linear arrangement of anchors and strings. Regardless, the initial text has to be brought into conformity with the anchoring policy pertinent to the present merging/weaving session prior to the step when edit operations on the anchored text are specified.

In the scenario of the transforming methods not being able to specify a clear or common anchoring policy, a policy of an anchor per character of the input text can be assumed. This gives the transformers complete flexibility in specifying whatever edit operations they seek. The anchor per character can be granularized to significantly fewer anchors in a later step after edit operations from transformers have been obtained. With character-level granularity, each transformer is free to assume whatever anchor it wishes (each anchor being identified by the location in the source file) and create edit operations using that. So only anchors that are actually used get created and manipulated by the transformers and not anchors for all characters in the file. After edits have all been collected from transformers, the set of anchors is converted to a canonical set as follows.
1. Collect the uses of anchors in the edit operations as p-uses and s-uses. A p-use or preceding use identifies an anchor use wherein the anchor is used to access a position preceding the character associated with the anchor (i.e. the start/before anchor qualifiers discussed later). An s-use or a succeeding use accesses a succeeding position relative to the anchor's character (the after/end anchor qualifiers discussed later). Add to this collected set of uses, a p-use of the first character in the input text and an s-use of the last character in the input text. Sort the set of uses by position so that an anchor use for a higher location character succeeds an anchor use for a lower location character and a p-use of an anchor precedes the s-use of the same anchor.
2. Let current use be a pointer into the sorted anchor uses list and let C be an initially empty canonical set of anchored strings. Traverse the list from the lowest position up (initial current use being the first use in the list) as follows until the current use pointer cannot be advanced any further:
   a. If the current use and the use succeeding the current use are a p-use and s-use respectively, then all the characters associated with the two anchors and in-between them, in the input text can be represented by one string to be anchored by the current use anchor. Place this string anchored by the current use anchor in the canonical set C and advance the current use pointer to the next use anchor (the s-use anchor), and continue the traversal of step 2.
   b. If the current use and the use succeeding the current use are both p-uses, then the character from the current use anchor's character and higher location ones up to but excluding the one associated with the succeeding p-use anchor can be represented by one string to be anchored by the current use anchor. Place this string anchored by the current use anchor in the canonical set and advance the current use pointer to the next use, and continue the traversal of step 2.
   c. If the current use and the use succeeding the current use are both s-uses, then all characters succeeding the current use anchor's character, up to and including the character associated with the succeeding s-use anchor's character can be represented by one string. The succeeding use anchor can be (location-wise modified and) re-used to anchor this string. Place this string anchored by the succeeding use anchor in the canonical set and advance the current use pointer to the next use, and continue the traversal of step 2.
   d. If the current use is an s-use and the use succeeding the current use is a p-use, then all characters succeeding the current use anchor's character, up to and excluding the character associated with the succeeding p-use anchor's character can be represented by one string to be anchored by a newly created anchor (pointing to the starting location of the string in the input text). Create the anchor and place this string anchored by the new anchor in the canonical set and advance the current use pointer to the next use, and continue the traversal of step 2.

The set of anchored strings collected as a result of the above traversal comprises the anchor-wise ordered, canonical anchored text suitable for the set of edit operations. Due to anchor reuse, the edit operations' anchor references in terms of p-uses and s-uses continue to be the same except for the succeeding s-use case of step 2(a) above, which has to be re-expressed in terms of the p-use anchor. In effect, the s-use anchor gets discarded in step 2a. The newly created anchor in step 2d forms a part of the canonical anchored text for completeness and is not referenced by the edit operations.

Step 1 above is straightforwardly obtained since (character-level) anchored text is a sorted structure. The above algorithm is straightforwardly simple and linear in terms of input text size.

In FIG. 2, once the revision plan comprising partially-ordered edit operations has been obtained on a suitable anchored text (e.g. a policy based one or the character-level granularized one described above), in step 28, the revision plan is implemented by ordered, interactive (or otherwise) execution of the edit operations on the anchored text. Anchored text allows greater expression of conflict-free editing and which minimizes the conflict encountered in the operation execution steps. The execution of edit operations and revision plan of step 30 are described in detail in the next section. Finally, in step 32, the edited anchored text can be saved as anchored text itself, or be printed into plain text before saving. The saved result is available to later merging/weaving sessions as the presently described one.

### Parallel Edit Language

The weaver notation is given via a grammar for an editing language called ParEdit, an example of which 100 is shown in FIG. 3. A preprocessed reference text, containing definition of reference anchors is obtained as shown by the production for Reference, by modifying the original text to insert anchors in-between characters. This partitions the original text characters so that each character is associated with a unique anchor and the original order among the text characters is retained, for say printing purposes. Anchored text allows finer control over text modification by defining several positions for editing vis-à-vis the reference text tied to reference anchors as well as on-going modifications as follows. Insertion of new characters can take place at the following positions: just before a set of reference characters tied to a reference anchor, before all new characters already inserted by other modifications prior to the reference characters, just after the reference characters, and after all new characters already inserted by other modifications after the reference characters. These positions are referenced by sub-anchors called before, start, after, and end respectively.

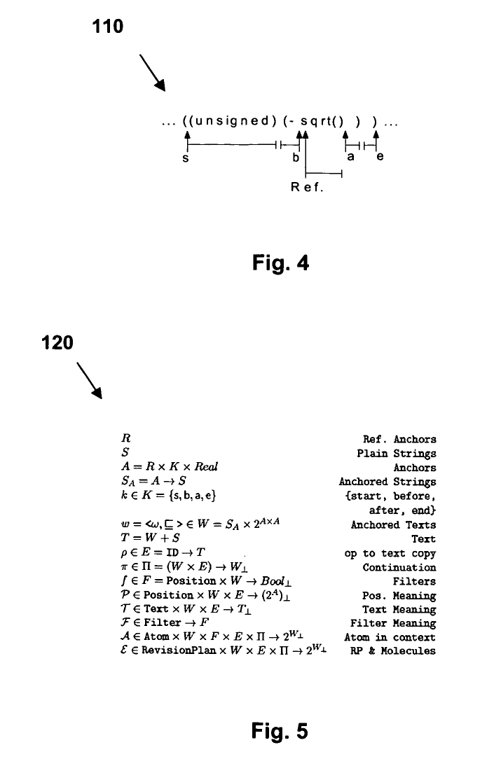

FIG. 4 illustrates anchors and sub-anchors for example text 110. Each anchor shows its associated string by the connected horizontal line. Each sub anchor is labelled by its initial character (i.e. s for start, b for before, a for after, and e for end). The sqrt( ) function string in reference text is modified using the sub-anchors as shown.

ParEdit allows six basic operations on anchored text, namely copy, cut and paste, suffixed by either S or T, standing for string (plain string) and text (text containing anchors) respectively. The operations specify operating positions or ranges (position pairs), wherein each position is a pair comprising a reference anchor and its sub-anchor. Operation ranges for cut and copy are inclusive ranges, so for instance cutting the entire current text can be done by specifying the start sub-anchor of the first reference anchor and the end sub-anchor of the last reference anchor. Each operation comprises an atomic edit action. Each atom is explicitly labelled, which allows flexibility to specify temporal order (partial order/schedule) among the edit operations at the finest granularity. The ID of copy operations also serves to label their copied text and is used by pasteT operations in pasting anchored text.

A sequence of atoms makes up an edit molecule. Syntactic merge occurs at the level of molecules. A molecule also specifies a filter function, using which the set of positions and ranges applicable to the molecule's atoms can be fine-tuned from among the many anchor copies possible in anchored text. So for instance, customised instantiation of the k^{th} macro invocation individually and separately from other macro invocations can be specified using the filter function for the customising molecule.

Related molecules are collected together as an analysis, e.g. Endian, loop index variable, and may be generated by an automatic or semi-automatic analyser for porting concerns. A revision plan is the result of a batch of analyses on the source program, all, or some of which may be chosen for implementation via a revision plan. As illustrated in FIG. 4, atoms can be written to accommodate changes due to other atoms, for say commutativity. Further cooperation is possible by allowing the position and text/string arguments of operations to be generated after inspection of the current state of anchored text, namely text copies and the overall working text. Such inspection/computation can be specified as a function application whose arguments are either text copies, or the overall text represented by a global ID, called working_text.

ParEdit function applications undergo an explicit dereferencing step of converting arguments (operation IDs) into text copies prior to the function call itself. Thereafter, all computations on the texts occur in a purely functional manner using (sugared) lambda calculus functions, so arbitrary computations can be specified. The filter functions specified with molecules themselves are two argument functions, the first argument taking the position under consideration and the second the current working text (in which the position has a meaning).

FIG. 5 shows the domains 120 used by the weaving semantics. Reference anchors comprise a standard enumerable domain, as do plain strings. Sub-anchors are converted to full-fledged anchors used to embed in and manipulate working texts. Each anchor contains its reference anchor component as well as its sub-anchor kind. Anchor copies are supported by explicit unique identities for each copy using real numbers. Using real numbers allows arbitrary replication of anchors within a fixed range, since a continuum of real numbers can be drawn upon for identities within any range. This allows local generation and manipulation of sorted, unique identities, in which the local property supports synchronisationless concurrent updates and being sorted (e.g. monotonically increasing identities) is useful for filter functions.

A working text, w (ε W, the set of all working texts), is a pair, comprising of a mapping from anchors to their corresponding strings and the relative order (layout precedence) among the anchors. An interleaved, continuation semantics is provided to enumerate the effect of all valid concurrent edit behaviours. A continuation semantics serves as the means to record the edit sequence implicit in any given interleaving. The following default semantics of ParEdit is taken: atoms are executed sequentially within a molecule and molecules are executed sequentially within an analysis. Analyses in a revision plan are unordered vis-à-vis each other, so all possible interleavings of the analyses have to be enumerated. A continuation maps the current working text (w) and text copies environment (ρ ε E) to the final working text. The mapping may not result in a valid final working text (represented by ⊥) depending upon the interleaved sequence of edit operations.

The meaning of a revision plan and the molecules contained within it is given by the semantic function E, which maps a revision plan, working text, environment, and continuation to the set of working texts possible for all valid edit interleavings. The semantic function is assisted by other semantic functions (P, 7, F, A), which carry out localised mappings for E. P maps a position, working text, and environment to a set of anchors (copies) if computable (the computation is arbitrary and may not terminate or yield a valid result, modeled by ⊥). Similarly, 7 maps to the meaning of text, if computable. F maps to a function straightforwardly, but the mapped-to function may not yield a Boolean answer on all its input. These functions are straightforwardly expressed in terms of standard semantic functions for the omitted functional computation language. A maps an atom, working text, filter context, environment, and continuation to the set of all possible answers including non-validity (⊥). Explicit checking for invalid operation execution is skipped in order to focus on valid behaviours. In order to retain a well-formed anchored text throughout the editing process and to prevent sub-anchors from scattering independently throughout the working text, anchored text operations are restricted as follows: A text cut or copy operation (cutT, copyT) may only specify a start anchor as the from position and an end anchor as the to position. A text paste operation (pasteT) may only specify a start anchor as its paste position. String operations (cutS, copyS, and pasteS) have no such restrictions placed upon them.

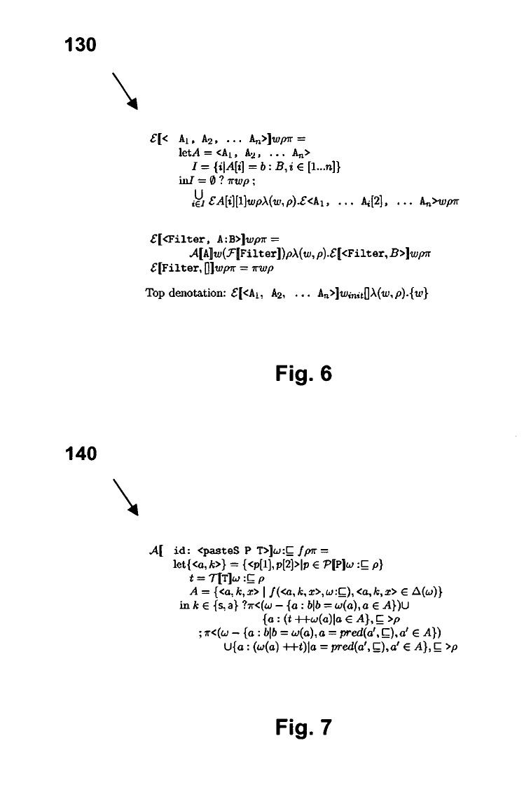

FIG. 6 specifies E 130 at the revision plan and molecules level. The notation used in FIG. 6 (and below) is as follows: A pair, <b, B> may also be written as b:B. Selectors for tuple components are written using 1-based array syntax. So for instance, the first component of a pair P can be obtained by P[1], and the second component by P[2]. Conditional expressions are written as: predicate ? consequent ; alternate. Δ is the dom function, used to obtain the domain of its argument function. Constructions of ω(ε S_{A}) treat it as using set notation, as a set of pairs and build accordingly. Otherwise 0) is also referenced using function notation mapping anchors to a strings co-domain. Other than this, standard semantic/set notation is used in our work.

In FIG. 6, E chooses one molecule at a time from the analyses and supports all possible continuations for this choice. The continuations cover the succeeding molecules from the analysis of the chosen one and the molecule sequences in other analyses. The union of these answers with the answers obtained by other initial molecule choices yields all working text derivations for the revision plan. The top-level denotation for the revision plan, as shown in FIG. 6, uses an initial working text that is the pre-processed source with basically the anchors embedded, an empty environment ([]), and an initial continuation that simply returns a working text wrapped up in a singleton set. The filter denoted for a chosen molecule is passed to all its atoms in evaluation sequence invoking A. Upon completion of the atom sequence of a molecule, the continuation takes weaving through the rest of the editing process.

FIG. 7 specifies A 140 for a string paste operation. For the paste position specified by reference anchor a and kind k, the set of all anchor copies which pass filter f have the string t pasted as follows. If kind k is s or a, the string is pre-pended to the string already associated with the given anchors. For kinds b or e, the strings are appended to the string associated with the predecessor anchors for identified anchors. This is as illustrated in FIG. 4, since a before anchor (similarly end) is a notional marker, which is always adjacent to the reference text and never lets characters accumulate between itself and the reference characters.

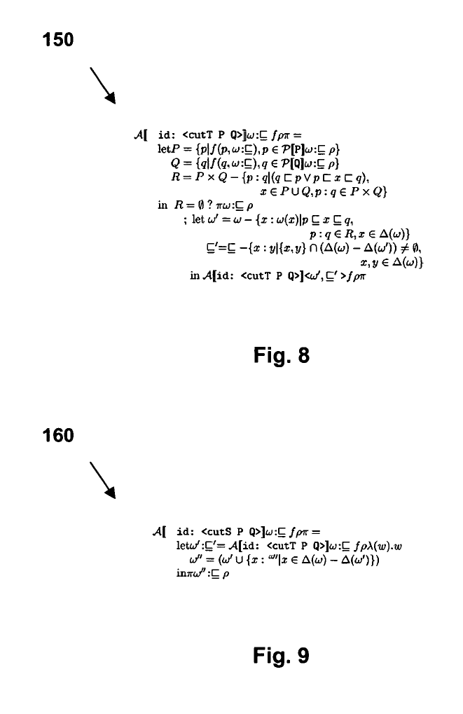

FIG. 8 specifies the denotation of an anchored text cut operation 150. Position sets P and Q are obtained after due filtering of anchor copies. R comprises adjacent <p, q> pairs (ε P×Q) such that p precedes q (adjacent means no other anchor from P or Q lies in between p and q). The text cut operation is defined recursively, wherein in one recursive step, the text between each pair of adjacent positions belonging to R is cut.

FIG. 9 specifies a string cut operation 160 in terms of an anchored text cut operation. The text that a cutT would eliminate is replaced back into the working text, except that each cut anchor is re-mapped to a null string before it is put back.

FIG. 10 specifies anchored text copy semantics 170. Only one well-formed pair of from and to anchors are allowed to be filtered through for the copy operation. The working text in-between the anchors is copied and the environment updated with the text copy at the operation id. String copy semantics is the same as anchored text copy semantics, except for a conversion of the anchored text to a plain string just prior to the environment update.

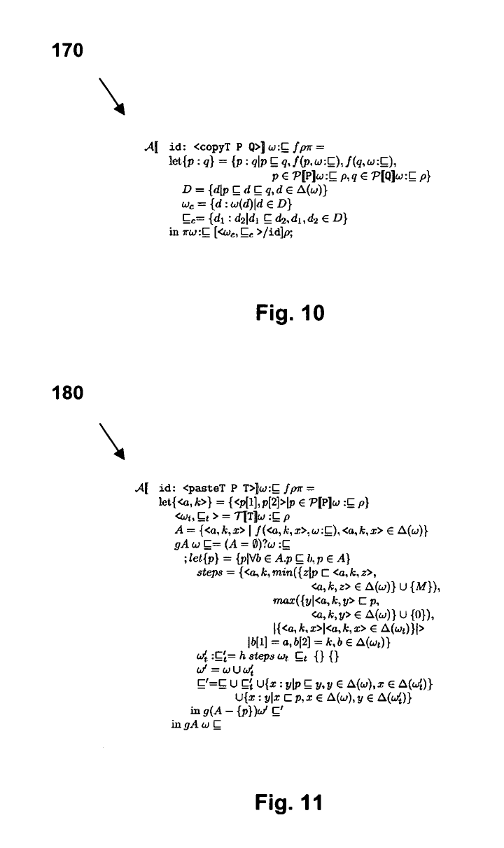

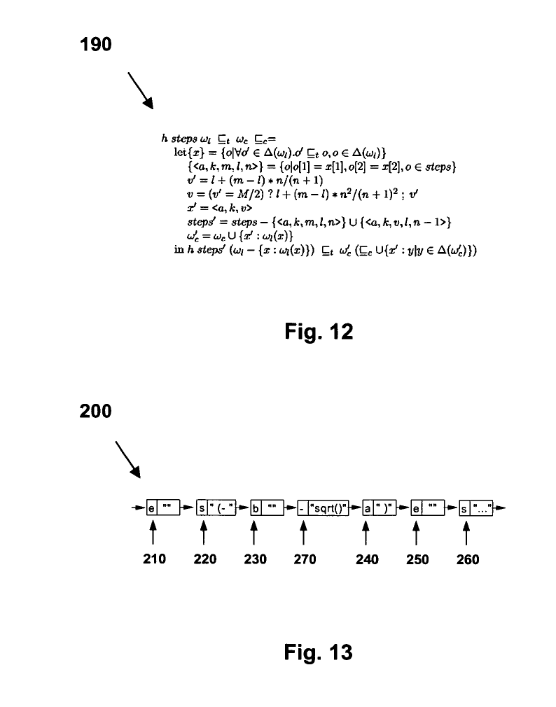

Pasting anchored text is relatively complex and is covered in FIGS. 11 and 12. In FIG. 11, the set of filtered paste anchors, A 180, is identified followed by the use of a recursive function g to paste at A's anchors one by one. In each recursive step, the most preceding member of A is identified as p, and anchors' identity information pertaining to a paste at p identified as steps.

Steps is a set of 5-tuples describing the text to be pasted at the paste anchor. The description includes the reference anchor and kind of individual anchors found in the text to be pasted. For each such anchor, the number of copies of such an anchor in the text to be pasted are identified (fifth element of the 5-tuple), as well as the real number identity of the immediately preceding such anchor copy before p, where the paste is supposed to occur (fourth element of the 5-tuple). If no immediately preceding anchor copy exists, then an identity 0 is identified. Similarly, an immediately succeeding (after p) anchor identity is identified (third element of the 5-tuple). If no succeeding anchor exists, then some positive constant M is identified. Once the steps information for each anchor contained in the to-be-pasted text is obtained then the pasting of the individual anchors in the same text can take place using real number identities that lie in-between the range defined by the pre-existing immediately-preceding and immediately-succeeding copies of an anchor at the paste position. In effect, the real number identities in the copied text available from p, the environment, are re-mapped to new identities pertinent to the paste position p using steps and a recursive function h described in FIG. 12. ω(similarly the precedence relation) merges the remapped anchored strings to the anchored strings in the current working text. The recursion is complete when the set of paste anchors A is exhausted.

The function h 190 in FIG. 12 shows the exemplary arithmetic needed for remapping anchor identities. The function reduces the set of leftover anchored strings ωₗ (second argument) obtained from the text copy (h is invoked with ωₜ in FIG. 11) in each step and constructs the re-mapped strings ω_{c} and the order relation at the same time. From ωₗ the most succeeding anchor is identified as x and remapped to x′ using one exemplary arithmetic function. The steps information for this anchor is modified to reflect that one less such anchor need be dealt with in the later recursive steps. The remapped text under construction is updated with this remapped anchor and the recursion continues till ωₗ is exhausted. The conditional involved in computing the remapped identity v ensures that no remapping ever regenerates the initial set of reference identities, for which the value M/2 is reserved.

It is straightforward to prove that for the exemplary arithmetic shown in FIG. 12, the range of identities obtained for pasted anchors fall in-between their immediately preceding and succeeding neighbours. This is bounded by 0 on the lower side and M on the upper side. The initial, preprocessed reference text can start out with any anchor identities between 0 and M(M/2 is the standard choice), and all copy and paste manipulations later, the anchor identities remain within the open range (0, M). If anchor <a, k, x> precedes anchor <a, k, y> then another invariant that holds is that x <y. Thus anchors of the same reference and kind remain sorted strictly monotonically and also bounded throughout the text manipulation process. This is a useful property to have for filter functions.

### Direct Offline Implementation and Online Emulation

The semantics above suggests a direct, association-list based implementation of working text as illustrated in FIG. 13. Working text's ω component 200 is comprised of anchors 210-260 as individual keys, and the strings they map to become values of the individual associations. The precedence order is provided by the listing order of the associations. Reference text is shown with an anonymous anchor 270 which cannot be used for associative access purposes. FIG. 13 illustrates a subset of FIG. 4's modifications—negation of sqrt( ), and highlights that b and e anchors' associations are always null—the corresponding text is shifted to s and a anchors respectively. The positions of b and e however serve to mark both preceding and succeeding string associations.

Environment implementation, ρ ε E is standard, as an association list of label, text pairs. Since labels accrue monotonically within an analysis, no pop operation is needed on the label stack. One stack per analysis, or one global stack can be used. The number of interleavings explodes combinatorially, with the initial choices of molecules having N candidates each (for N analyses). As individual analyses begin to get exhausted, the number of choices begin to go down, with the number of interleavings possible being a function of the sort: N*N*N . . . *(N−1)*(N−1)* . . . *(N−1 )*(N−2)* . . . . This function has a conservative lower bound of max(N!, N^{K}), and an upper bound of N^{NK+T} where K is the minimum number of molecules per analysis and NK+T is the total number of molecules in all the analyses. Hence the interleavings, though exponential, are enumerable. The size of individual molecule computations however, is unbounded, since arbitrary computations are allowed. A direct implementation of ParEdit semantics would fork off all the distinct interleavings possible in concurrence, and let the valid ones generate their answers in finite time, allowing a monotonically increasing set of valid results to accrue over time. Of more interest however is the ability to obtain one valid answer quickly using limited space. A backtracking sequential implementation that allows user intervention for unbounded molecules can be constructed as follows: For a given interleaving, the implementation forks each molecule as a separate, interruptible thread, which can be monitored and abandoned gracefully based on automatic timeout or user discretion. The implementation is sequential, as it forks only one molecule at one time. If a molecule is abandoned, the interleaving it belongs to is rolled back to the choice point when the molecule was picked. The molecule's choice is recorded as abandoned and another choice made. Backtracking occurs as far back as needed to find an interleaved sequence that makes progress. The first sequence that executes the molecules of all analyses validly yields its final working text as the final answer.

The sequential, backtracking implementation described above is an offline implementation since it enumerates the large but finite set of interleavings. An online implementation would try to work with an interleaving that arises naturally, without a pre-determined method for generating interleavings. Building such an implementation requires somewhat powerful synchronisation primitives. Since anchored text can be viewed as a datatype with six primitive operations (cut, paste, copy for text and strings), it is capable of emulating a FIFO queue as follows—consider a queue insert as a text paste operation with distinct end character markers. Delete symmetrically becomes a text cut operation. Just these two operations ensure that a concurrent FIFO queue can be emulated by a concurrent anchored text object. Since FIFO queues have a consensus number two, reflecting their power to solve a consensus problem in a system of two threads, online anchored text similarly has a consensus number of at least 2 and cannot be implemented with a wait-free property using minimal synchronisation primitives, namely simple atomic registers of the parallel random access memory (PRAM) model, which have a consensus number of one. The shift from an offline to an online anchored text implementation must be partial in order to enable a wait-free implementation using atomic registers, like the system in. On the other hand, an online implementation that abandons the wait-free property and uses higher power synchronisation primitives (e.g. locks) can straightforwardly use N threads, one per analysis and a lock to control access to the working text. Each thread seeks a lock on working text prior to executing a molecule. Thus the interleaving arrived at by the multiple threads is a dynamically determined, online sequence.

A partial online alternative here is an emulation of online behaviour using atomic registers by allowing each analysis thread to define its own fixed molecule scheduling time. With fixed times, regardless of the actual speeds of individual threads in computing molecules, the same deterministic interleaving of molecules is arrived at. The schedule can be dynamically determined (per analysis using for example, the time function), as and when the molecules appear or be pre-fixed (statically estimated). The fixing of schedule time orders molecules across the analyses as a total order, except for ties in scheduling time, which can be broken using some deterministic scheme (e.g. thread priority).

Each analysis thread can read the schedule-tagged molecule sequence of others to find out which is next eligible molecule (next schedule tag). The shared working text is updated by the analysis thread of the next eligible molecule, once the preceding molecule's update is over. Each analysis also tags its molecules with a done/pending status so that each analysis can decide when it can execute its eligible molecule. These flags are implemented as shared memory (registers) with spin waiting to ensure progress in status. Spin waiting can be avoided by using non-pre-emptive threads and self-descheduling by waiting threads.

A scheduled total order may not turn out to be a valid interleaving, so backtracking to determine other interleavings may be carried out. Tie points in the schedule may be revisited, to explore the choices not taken. Another option is to decide on an alternative set of analysis speeds to re-evaluate the schedule tags. Finally, each time backtracking moves back a molecule, user intervention can be sought to propose an unexplored molecule alternative.

### Speculative Scheduling with Atomic Registers

Speculative scheduling can be used to introduce additional concurrency in the online emulation scheme for operations that have localised dependencies and effect on the working text. Operations with extensive filter computations or copy operations need not be executed speculatively, since they need to inspect the working text and hence need careful synchronisation with it. The other operations can be executed in speculative and reconciling parts, the latter interpreting and completing the speculative parts at the synchronisation points brought on by copy and (heavy) filtering operations, or the end of the analysis.

Instead of being an association list, the working text gets reorganised as a tree, with each entry in the tree being indexed by an associated anchor key. Each entry, or bucket, in the tree comprises of one bin per analysis, each bin being a queue containing atoms. Initially the tree is a special case—simply a list—comprising of initial anchors and corresponding text. The list grows into a regular tree due to pasteT operations that get inserted into analysis bins. Each pasteT insertion starts a subtree rooted in the operation.

Except at synchronisation points, no interpretation of deposited operations takes place. Operations placed in a bucket are tagged with their schedule number, so interpretation of the operations can be carried out unambiguously, later, post deposition. Operations across multiple anchors are deposited separately in the corresponding buckets. As before, the schedule numbers are explicitly disambiguated at tie points.

A synchronisation point (like a copy operation) has a clearcut schedule tag and hence engenders interpretation of operations in affected buckets for operations with preceding schedule tags.

A key principle (that can be proven by induction over operation sequences) behind working text thus is to be a monotonically increasing data structure in which deposition can always take place (the relevant bins are always there) and to synchronise by replaying the deposited operations to the appropriate schedule tag in order to get the digested working text state.

A cutT operation therefore simply deposits itself in the relevant buckets to flag them as cut without removing any data structure. After an analysis completes all its depositions, it marks this end of deposition phase as an explicit flag and then shifts into an interpretation mode, wherein it becomes responsible for interpreting the subtrees rooted in a statically-allocated partition of the initial buckets. The interpretation proceeds over all bins where the thread can make progress independently of others. Once a thread is done with its interpretation mode, it shifts into a print mode whereby it converts to string form (or another form) the region of anchored text interpreted by it. The analysis with the last schedule tag integrates the disjoint anchored text portions after completing its own portion and spin-waiting the completions of all others.

All implementations described thus far proceed with single/multiple reader, single writer atomic registers, with threads undergoing spin waiting on progress registers upon need. In a pragmatic implementation, the expense of spin waiting can be avoided by letting a thread explicitly deschedule itself upon failing to find a progress indicator in a satisfactory state. All threads either compute without pre-emption, or explicitly deschedule themselves instead of spin waiting. At least one thread would always be enabled to make progress, till the end of computation is reached.

### Syntactic Merging

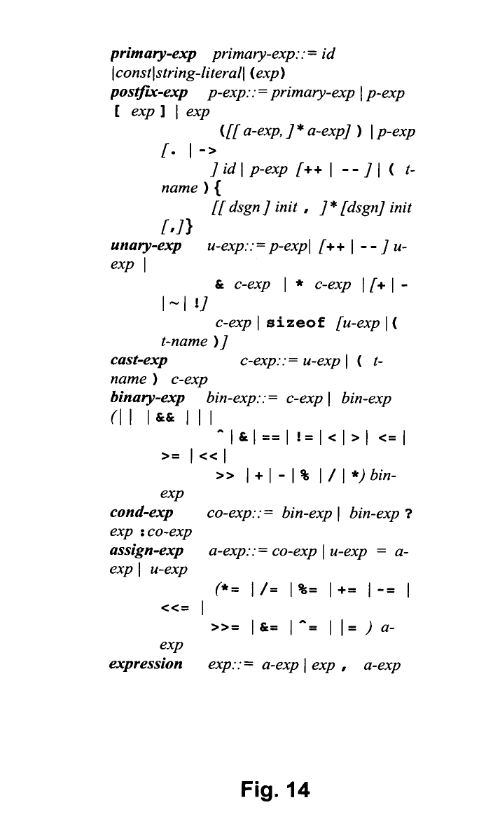

Syntactic merging is carried out at a molecule level, which carries with it a notion of rectification of individual porting concerns. The machinery, omitted from ParEdit thus far, involves syntax and optional semantic (type) checking of the changed code due to a molecule. One or more high-level syntactic entities are identified per molecule within which all changes due to a molecule take place. This is specified as a second, succeeding sequence of edit operations per molecule to construct a copy of the high-level entities. Each entity is then labelled with its most precise syntax non-terminal, examples of which for C99 expressions are shown in bold letters in FIG. 14. Each entity can optionally be labelled with its type specification also and the type and syntax label can also be a partially derived, explicitly-typed parse-tree (up to the level of non-terminals). The choice of syntax and type labels classifies the dialect of the merged code. In case the merged code is a mixed dialect code, we also allow specification of disjunctive labels within a partially-derived parse tree. Partial syntax merge checking can also be carried out using (hierarchical) lightweight patterns specification rules (eg. as taught in Murphy, G. C., “Lightweight Lexical Source Model Extraction”, ACM Trans. Soft. Eng. Method., Vol. 5, No. 3, (July 1996), pp 262-292), which allows regular expression based pattern checking to verify the presence of at least one pattern instance within a code region. Thus fragments within a code can be verified, ignoring discrepancies due to mixed dialects, etc.

The approach of verifying syntax merging based upon explicit syntax labels may be implemented using a hand-crafted recursive-descent parser. One approach is to generate stub code to convert a high-level entity into a top-level definition or compilation unit that can be compiled incrementally. The ability to verify merged code at distinct source or target dialect settings is important. Finally, invoking a syntax and type-checking frontend on a well-defined dialect requires being able to handle and ignore errors due to unknown variables related to symbol table entries that do not find consistent expression in the dialect applied to the merged code compilation. In the context of a recursive-descent parser like EDG, this is relatively straightforward to do, as the frontend skips the unknown variables relatively gracefully.

### Discussion

The embodiment described takes merge systems evolution one step further, by capturing more information in terms of anchors for the merge purpose. The information is extra in both the state component (working text) and the operations component (cut, copy, paste). The basic assumption of operations-based merging is that operation commutation vis-à-vis initial program indicates lack of conflict. Automatic conflict resolution is enhanced by increasing the extent of operation commutation. For example, consider two parallel lines of development in which one introduces a name refactoring and the other another variable instance with the old name. While state-based systems would miss this conflict as an error without fixing it, an operations-based system will only flag the same as a conflict by noticing the lack of commutation of the two transformations. This would allow a user the opportunity to manually carry out a suggested fix of temporally ordering the refactoring after the name introduction. In contrast to this, using anchored text, if the name introduction is defined as copyT of the anchored text containing the name followed by pasteT of the same, while name refactoring is defined as a cutS followed by a pasteS over the range of the name, the two operations will automatically commute and carry out the merge properly with the intended fix already included in it. Anchored text is able to carry out this conflict resolution effectively essentially because the anchors can serve as connectors between symbols, just as a symbol table does in abstract syntax graph (ASG) representations of programs.

Another example of automatic conflict elimination is the pretty print operation in parallel lines of development, which may cause many localised conflicts in state-based systems which detect conflicts at the granularity of individual lines of text. Operations-based merging would recognise pretty-print conflict at the operation-level (a pretty-print operation), while anchored text would allow diffuse (automatic/manual) pretty prints by allowing anchored whitespace tokens to be manipulated without raising syntactic/semantic conflicts about the program text itself.

As the pretty-print example above illustrates, being kernel operations-based is not tied to understanding of a large heterogeneous set of operations and has the advantage of finer granularity and minimality (operations-wise) compared to generic operation transformation systems (which attempt to capture a large and heterogeneous set of operations). An advantage of knowing the specific (heterogeneous) operation context is its presentation to a user in conflict resolution contexts. This can be obtained for anchored text also by storing specific operation information as an annotation to the translated kernel operations.

While the present disclosure targets (commercial) text-based merge systems with their advantage of generality, the commutative benefit of this approach can be brought about in AST/ASG-based merge systems also by introducing anchor annotations explicitly in their node structures. For text-based merge systems, a new kernel system for text-based operations merging is provided, comprising of cut, copy and paste operations. The form checking rules bring about specificity to the merging context by carrying the syntax checking in individual merge contexts.

### Implementation

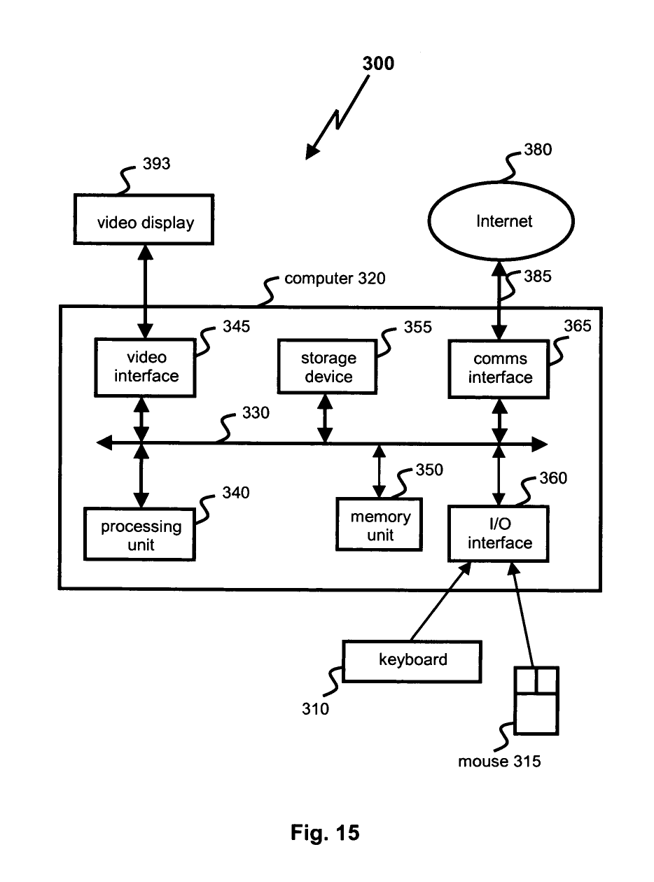

FIG. 15 shows a schematic block diagram of a computer system 300 that can be used to practice the methods described herein. More specifically, the computer system 300 is provided for executing computer software that is programmed to transform plain text to anchored text, to weave two or more electronic plain texts, and to merge two or more plain texts. The computer software executes under an operating system such as MS Windows 2000™, MS Windows XP™ or Linux™ installed on the computer system 300.

The computer software involves a set of programmed logic instructions that may be executed by the computer system 300 for instructing the computer system 300 to perform predetermined functions specified by those instructions. The computer software may be expressed or recorded in any language, code or notation that comprises a set of instructions intended to cause a compatible information processing system to perform particular functions, either directly or after conversion to another language, code or notation.

The computer software program comprises statements in a computer language. The computer program may be processed using a compiler into a binary format suitable for execution by the operating system. The computer program is programmed in a manner that involves various software components, or code, that perform particular steps of the methods described hereinbefore.

The components of the computer system 300 comprise: a computer 320, input devices 310, 315 and a video display 390. The computer 320 comprises: a processing unit 340, a memory unit 350, an input/output (I/O) interface 360, a communications interface 365, a video interface 345, and a storage device 355. The computer 320 may comprise more than one of any of the foregoing units, interfaces, and devices.

The processing unit 340 may comprise one or more processors that execute the operating system and the computer software executing under the operating system. The memory unit 350 may comprise random access memory (RAM), read-only memory (ROM), flash memory and/or any other type of memory known in the art for use under direction of the processing unit 340.

The video interface 345 is connected to the video display 390 and provides video signals for display on the video display 390. User input to operate the computer 320 is provided via the input devices 310 and 315, comprising a keyboard and a mouse, respectively. The storage device 355 may comprise a disk drive or any other suitable non-volatile storage medium.

Each of the components of the computer 320 is connected to a bus 330 that comprises data, address, and control buses, to allow the components to communicate with each other via the bus 330.

The computer system 300 may be connected to one or more other similar computers via the communications interface 365 using a communication channel 385 to a network 380, represented as the Internet.

The computer software program may be provided as a computer program product, and recorded on a portable storage medium. In this case, the computer software program is accessible by the computer system 300 from the storage device 355. Alternatively, the computer software may be accessible directly from the network 380 by the computer 320. In either case, a user can interact with the computer system 300 using the keyboard 310 and mouse 315 to operate the programmed computer software executing on the computer 320.

The computer system 300 has been described for illustrative purposes. Accordingly, the foregoing description relates to an example of a particular type of computer system such as a personal computer (PC), which is suitable for practicing the methods and computer program products described hereinbefore. Those skilled in the computer programming arts would readily appreciate that alternative configurations or types of computer systems may be used to practice the methods and computer program products described hereinbefore.

1. A method for transforming an electronic plain text to an electronic anchored text, comprising inserting anchors located between characters in said plain text, each character having a unique association with a nearest preceding or succeeding anchor, and each anchor serving as a join point and specifying a predetermined state and a predetermined operation.

2. The method of claim 1, wherein said predetermined operations act on one or more of:
(a) only the anchor;
(b) the anchor and a preceding set of characters; and
(c) the anchor and a succeeding set of characters.

3. The method of claim 2, wherein said predetermined operations include cut, copy and paste.

4. The method of claim 1, wherein there is one anchor per lexer token of said plain text characters.

5. The method of claim 1, further comprising inserting one or more subanchors located between two adjacent anchors, a subanchor delineating a boundary of an additional text region between said two adjacent anchors and being grouped with one of said two adjacent anchors, and each subanchor serving as a join point and specifying a predetermined state and a predetermined operation.

6. The method of claim 5, wherein said grouping with an adjacent anchor includes either of (i) a preceding anchor and its associated text, and (ii) a succeeding anchor and its associated text.

7. The method of claim 1, wherein said predetermined state includes either working anchored text or plain character strings and a partial ordering of execution among the predetermined operations on said working text and plain strings.

8. A method of weaving two or more electronic plain texts comprising:
transforming each said electronic plain text to an electronic anchored text by inserting anchors located between characters in said plain text, wherein each character has a unique association with a nearest preceding or succeeding adjacent anchor, and each anchor serves as a join point and specifies a predetermined state and a predetermined operation; and
performing one or more of the operations of copying, cutting and pasting anchored text or character strings associated with a said anchor from one said anchored text to another anchor point in another said anchored text.

9. The method of claim 1, wherein said predetermined operations act on one or more of:
(a) only the anchor;
(b) the anchor and a preceding set of characters; and
(c) the anchor and a succeeding set of characters.

10. The method of claim 9, wherein said predetermined operations include cut, copy and paste.

11. The method of claim 8, wherein there is one anchor per lexer token of said plain text characters.

12. The method of claim 8, further comprising inserting one or more subanchors located between two adjacent anchors, a subanchor delineating a boundary of an additional text region between said two adjacent anchors and being grouped with one of said two adjacent anchors, and each subanchor serving as a join point and specifying a predetermined state and a predetermined operation.

13. The method of claim 12, wherein said grouping with an adjacent anchor includes either of (i) a preceding anchor and its associated text, and (ii) a succeeding anchor and its associated text.

14. The method of claim 8, wherein said predetermined state includes either working anchored text or plain character strings and a partial ordering of execution among the predetermined operations on said working text and plain strings.

15. A method of merging two or more electronic plain texts comprising:
transforming each said electronic plain text to an electronic anchored text by inserting anchors located between characters in said plain text, wherein each character has a unique association with a nearest preceding or succeeding adjacent anchor, and each anchor serves as a join point and specifies a predetermined state and a predetermined operation;
identifying differences among two plain texts and expressing the differences as a part of the said predetermined operations; and
executing the predetermined operations on one of the transformed texts to bring it to a merged state.

16. The method of claim 15, wherein the step of identifying the differences among the two plain texts is performed from an ancestor text.

17. A method of versioning electronic plain text starting from an ancestor text common to descendent versions thereof, comprising:
transforming each said ancestor plain text to an electronic anchored text by inserting anchors located between characters in said plain text, wherein each character has a unique association with a nearest preceding or succeeding adjacent anchor, and each anchor serves as a join point and specifies a predetermined state and a predetermined operation;
specifying descendent versions of said transformed ancestor text using anchored text operations; and
executing said anchored text operations from any one version on to the anchored text of another version to merge changes of the first version into the state of the second version.

18. A system for transforming an electronic plain text to an electronic anchored text, comprising computational means for inserting anchors located between characters in said plain text, each character having a unique association with a nearest preceding or succeeding anchor, and each anchor serving as a join point and specifying a predetermined state and a predetermined operation.

19. A system for weaving two or more electronic plain texts comprising:
computational means for transforming each said electronic plain text to an electronic anchored text by inserting anchors located between characters in said plain text, wherein each character has a unique association with a nearest preceding or succeeding adjacent anchor, and each anchor serves as a join point and specifies a predetermined state and a predetermined operation; and
computational means for performing one or more of the operations of copying, cutting and pasting anchored text or character strings associated with a said anchor from one said anchored text to another anchor point in another said anchored text.

20. A computer program product comprising a computer program storage medium and a computer program stored thereon for transforming an electronic plain text to an electronic anchored text, said computer program including code means to insert anchors located between characters in said plain text, each character having a unique association with a nearest preceding or succeeding anchor, and each anchor serving as a join point and specifying a predetermined state and a predetermined operation.

21. A computer program product comprising a computer program storage medium and a computer program stored thereon for merging two or more electronic plain texts, said computer program including code means for:
transforming each said electronic plain text to an electronic anchored text by inserting anchors located between characters in said plain text, wherein each character has a unique association with a nearest preceding or succeeding adjacent anchor, and each anchor serves as a join point and specifies a predetermined state and a predetermined operation; and
performing one or more of the operations of copying, cutting and pasting anchored text or character strings associated with a said anchor from one said anchored text to another anchor point in another said anchored text.
